(19) United States
(12) Patent Application Publication
(10) Pub. No.: US 2010/0185726 A1
(43) Pub. Date: Jul. 22, 2010

(54) METHOD AND SYSTEM FOR PROVIDING ADVERTISEMENTS OVER A DATA NETWORK AND EMBEDDING THEM INTO PRINTED OR COPIED DOCUMENTS

(75) Inventors: Eyal KEDEM, Rehovot (IL); Itamar SHAFIR, Tel-Aviv (IL)

Correspondence Address: OLIFF & BERRIDGE, PLC, P.O. BOX 320850, ALEXANDRIA, VA, 22320-4850, US

(73) Assignee: FRINT MEDIA GROUP (2008) LTD., TEL-AVIV (IL)

(21) Appl. No.: 12/690,406

(22) Filed: Jan. 20, 2010

Related U.S. Application Data
(60) Provisional application No. 61/146,374, filed on Jan. 22, 2009.

(51) Int. Cl. G06F 15/16

(52) U.S. Cl. 709/203

(57) ABSTRACT

The present invention relates to a method and advertising management system configured to provide a plurality of advertisements over a data network and embed said plurality of advertisements into documents to be printed or copied by means of a plurality of users, said system comprising: (a) an application management server configured to enable an advertiser to set up an advertising campaign by enabling said advertiser to define one or more advertisements along with defining at least one advertising criterion, giving rise to one or more predefined rules; and (b) an advertisement management server configured to enable embedding at least one of said one or more advertisements into a document to be printed or copied, according to said one or more predefined rules.

### FIELD OF THE INVENTION

The present invention relates to advertising systems. More particularly, the present invention relates to a method and system for providing advertisements over a data network (such as the Internet, cellular network, LAN (Local Area Network), and the like), and then embedding them into printed and/or copied documents.

### BACKGROUND OF THE INVENTION

Nowadays, every institution, such as a school, college, university, hospital, etc. uses copy machines and printers on a vast scale, enabling users (e.g., pupils, students) to copy or print documents for a predefined cost. Payment is usually made by using a designated ID (identification) card, such as a college/university ID debit card or a personal credit card, and can cost, for example, $0.05 per a copied or printed page of a document.

According to the prior art, when a user prints a document, an advertisement can be embedded into it, enabling advertising various products or services. For example, according to JP11192760, a synthesis circuit is provided, which synthesizes an image, downloaded from a network. An image is processed by means of an image advertising server, enabling inserting advertisements by using a processing unit. Also, according to JP11192760A, an advertising medium is established, providing services to a user at a lower price than is normally charged.

JP2005123988 discloses an advertisement system, which utilizes copy paper as an advertisement medium. According to JP2005123988, the advertisement system has means for inputting and storing advertisement data in the copy machine; means for reading and storing original data to be copied; means for selecting and inputting paper, on which the advertisement is to be printed, and paper on which the advertisement will not be printed; etc.

JP2004341633 relates to an advertising system for providing advertisements to users that use a printer or copying machine. According to JP2004341633, a printer or copying machine comprises a users' identification code for identifying each user and sending a numeric value depending on an amount of documents printed with advertisements, which are downloaded from an advertising server.

According to JP8256256, a copying machine and an advertisement management server are connected to a network. An advertisement area detection section detects a margin space area from an original image read by an original input section of the copying machine. Upon receipt of the request from the copying machine, an advertisement image selection section of the advertisement management server selects an advertisement image close to a shape of the margin space area, and then the selected advertisement image is transferred to the copying machine. In turn, the copying machine synthesizes, then transfers, the advertisement image onto the margin space area of the original image.

According to JP11355549A2, a digital copying machine displays an operation indication image on a control panel and lets a user select the advertisement charge and the size of advertisement image. Based on this condition, an image editing part performs processing through an image processing part, synthesizes original image information and advertisement image information through an image information synthesizing part and performs corresponding image processing, according to the advertisement charge selected by the user.

JP2004007782 relates to inserting an advertisement into an image without affecting the quality of an original image, when copying a document by means of a copying machine.

There is a need in the prior art to provide a personalized media platform (system) over a data network (such as the Internet, cellular network, LAN, etc.) that enables copy machine/printer users (e.g., pupils, students) to print and/or copy documents for a lower cost in exchange for providing advertisements within the printed and/or copied documents; i.e., there is a need to enable users to get a predefined discount (e.g., 20% discount) for placing advertisements within the printed/copied documents. In addition, there is a need in the prior art to provide a personalized media platform, which will provide to advertisers a relatively high level of users' segmentation, enabling said advertisers to designate their advertisements to particular users, which have one or more predefined characteristics, answering advertisers' needs.

### SUMMARY OF THE INVENTION

The present invention relates to a method and advertising management system for providing advertisements over a data network (such as the Internet, cellular network, LAN (Local Area Network), and the like), and then embedding them into printed and/or copied documents.

An advertising management system is configured to provide a plurality of advertisements over a data network and embed said plurality of advertisements into documents to be printed or copied by means of a plurality of users, said system comprising:
a) an application management server configured to enable an advertiser to set up an advertising campaign by enabling said advertiser to define one or more advertisements along with defining at least one advertising criterion, giving rise to one or more predefined rules; and
b) an advertisement management server configured to enable embedding at least one of said one or more advertisements into a document to be printed or copied, according to said one or more predefined rules.

According to an embodiment of the present invention, the advertisement management server further embeds the at least one of the one or more advertisements, according to one or more rules predefined by a provider of said advertising management system.

According to another embodiment of the present invention, the advertising management system determines a combination of advertisements to be embedded within the document to be printed or copied.

According to still another embodiment of the present invention, the combination of advertisements to be embedded is determined according to one or more rules predefined by a provider of said advertising management system and/or the advertiser.

According to still another embodiment of the present invention, the advertising management system further comprises a communication server configured to provide a gateway between the application management server and advertisement management server.

According to still another embodiment of the present invention, the application management server and advertisement management server are unified and physically located on the same server.

According to a further embodiment of the present invention, the at least one of the one or more advertisements is embedded into the document to be printed or copied substantially in real-time.

According to an embodiment of the present invention, the application management server further comprises a database.

According to another embodiment of the present invention, the database is used for one or more of the following: a) storing the advertisements to be embedded into the documents to be printed or copied; b) storing personal details of the users who print or copy said documents; and c) storing data being related to said users.

According to still another embodiment of the present invention, the advertisement management server further comprises a database.

According to a further embodiment of the present invention, the database is used for one or more of the following: a) enabling caching of advertisements provided from the application management server; b) storing personal details of the users who print or copy said documents; and c) storing data being related to said users.

A method of providing a plurality of advertisements over a data network and enabling embedding them into documents to be printed or copied by means of a plurality of users comprises:
a) enabling an advertiser to set up an advertising campaign by enabling him to define one or more advertisements along with defining at least one advertising criterion, giving rise to one or more predefined rules; and
b) enabling embedding at least one of said one or more advertisements into a document to be printed or copied, according to said one or more predefined rules.

A program storage device readable by machine, tangibly embodying a program of instructions executable by the machine to perform a method of providing a plurality of advertisements over a data network and enabling embedding them into documents to be printed or copied by means of a plurality of users, said method comprising:
a) enabling an advertiser to set up an advertising campaign by enabling him to define one or more advertisements along with defining at least one advertising criterion, giving rise to one or more predefined rules; and
b) enabling embedding at least one of said one or more advertisements into a document to be printed or copied, according to said one or more predefined rules.

### BRIEF DESCRIPTION OF THE DRAWINGS

In order to understand the invention and to see how it may be carried out in practice, various embodiments will now be described, by way of non-limiting examples only, with reference to the accompanying drawings, in which:

FIG. 1 is a schematic illustration of a system connected to a data network configured to provide advertisements over said data network and embed them into printed and/or copied documents, according to an embodiment of the present invention; and

FIG. 2 is a sample flow chart for providing advertisements within a printed and/or copied document, according to an embodiment of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE EMBODIMENTS

In the following detailed description, numerous specific details are set forth in order to provide a thorough understanding of the invention. However, it will be understood by those skilled in the art that the present invention may be practiced without these specific details. In other instances, well-known methods, systems, procedures, components, circuits and the like have not been described in detail so as not to obscure the present invention.

Unless specifically stated otherwise, as apparent from the following discussions, it is appreciated that throughout the specification discussions utilizing terms such as “processing”, “computing”, “calculating”, “determining”, or the like, refer to the action and/or processes of a computer that manipulate and/or transform data into other data, said data represented as physical, e.g. such as electronic, quantities. The term “computer” or “machine” should be expansively construed to cover any kind of electronic device with data processing capabilities, including, by way of a non-limiting example, personal computers, servers, computing systems, communication devices, processors (e.g. digital signal processor (DSP), microcontrollers, field programmable gate array (FPGA), application specific integrated circuit (ASIC), etc.) and other electronic computing devices. Also, operations in accordance with the teachings herein may be performed by a computer specially constructed for the desired purposes or by a general purpose computer specially configured for the desired purpose by a computer program stored in a computer readable storage medium.

Hereinafter, wherein the term advertisement is used, it should be noted that it relates to any kind of advertisement, such as a textual advertisement, image, picture, logo, announcement, message, and the like. Further, it should be noted that the term “advertisement” also refers to the term “ad”, both of which are used interchangeably. In addition, when the term “document” is mentioned, it refers to any data that can be printed and/or copied, such as textual data, picture, image, and the like.

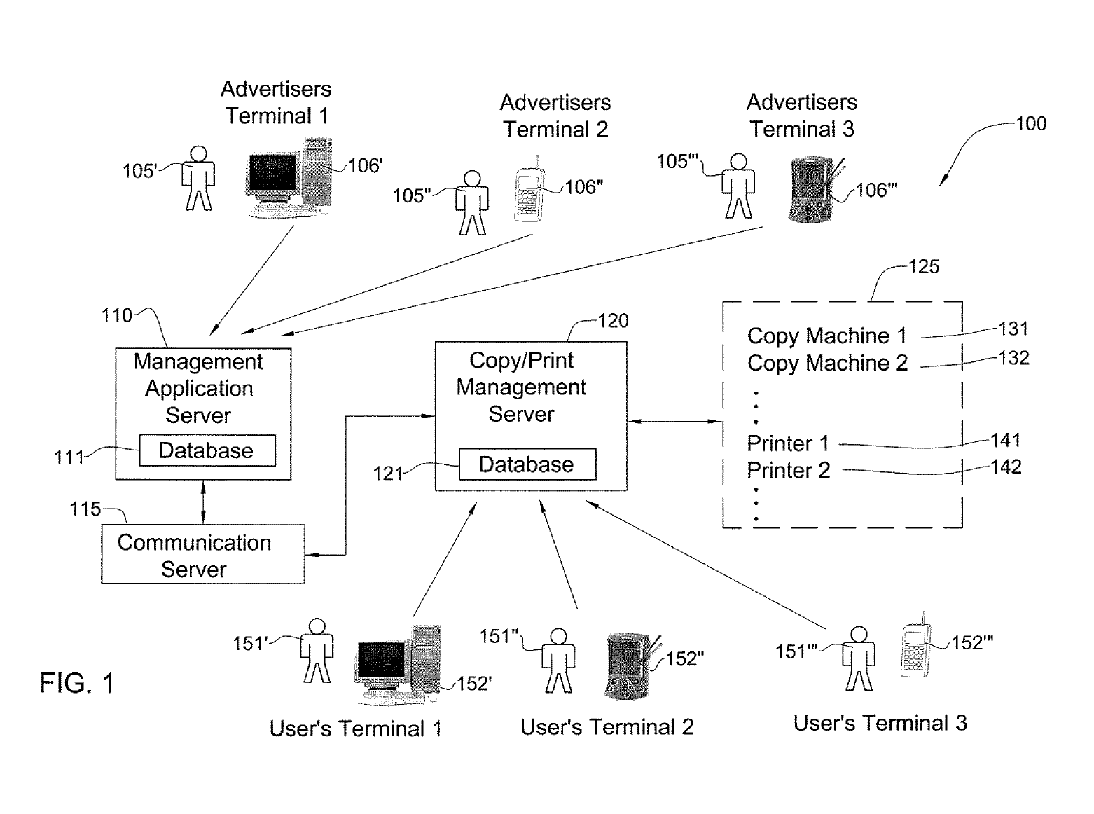

FIG. 1 is a schematic illustration of a system 100 connected to a data network (such as the Internet, cellular network, LAN, etc.) configured to provide advertisements over said data network and embed them into printed and/or copied documents, according to an embodiment of the present invention. System 100 comprises a Management Application Server 110 for enabling a plurality of advertisers (e.g., resellers) to set up their advertising campaigns according to one or more predefined criteria (e.g., users' geographic location, age, field of interests, hobbies, priority, and any other criterion), giving rise to one or more predefined rules to be applied to corresponding advertising campaigns; a Copy/Print (Advertisement) Management Server 120 for processing advertisements and enabling embedding said advertisements into printed or copied documents according to the one or more predefined rules, which can be either defined by advertisers and/or by a provider of system 100 (e.g., priority of each advertisement, users' profile related rules, users' location-based rules, document-based rules (such as a minimal number of pages of the document) and the like); optionally, a Communication Server 115 for providing a gateway (for handling data traffic) between said Application Server 110 and said Copy/Print Management Server 120; and a plurality of copy machines and/or printers 125 for printing/copying documents with one or more embedded advertisements.

According to an embodiment of the present invention, Management Application Server 110 comprises a management application for managing advertising campaigns. Advertisers 105′, 105″ and 105″ set up their advertising account over a data network by surfing, for example, to a dedicated Web site from their terminals, such as personal computer (PC) 106′, cellular phone 106″, PDA (Personal Digital Assistance) 106′″, and the like. After setting up an account, each advertiser can login into said management application for defining his advertising campaigns (e.g., defining one or more advertisements, setting one or more rules for each advertisement, defining priority for each advertisement, and the like). It should be noted that the advertiser can define his advertising campaign according to one or more predefined templates, comprising a set of predefined rules (advertising criteria). Further, according to another embodiment of the present invention, system 100 provides advertisers with a relatively high-level of users' segmentation, enabling said advertisers to designate their advertisements to particular users, which have one or more predefined characteristics that answer their advertising needs. For example, if a fashion retailer wishes to promote a new summer line for young adults, he can login into said management application and select one or more corresponding copy machines or printers (e.g., located in different countries, different time zones, different institutions, and the like), which are mainly used by young adults (e.g., students). Then, the above fashion retailer can place advertisements according to personal details of each student, which prints and/or copies documents by using system 100. It should be noted that said personal details can include students' geographic location, age, field of interests, hobbies and any other criteria. In addition, it should be noted that personal details of each student (user of system 100) can be organized as a user's profile to be presented to advertisers, allowing them to select targeted users, who are most appropriate for their particular advertising campaigns.

According to another embodiment of the present invention, Management Application Server 110 comprises a database 111 of all advertisements (e.g., advertisements received and/or prepared by advertisers). In addition, the database can store users' segmentation and personal details of said users (e.g., users 151′, 151″ and 151′″). Further, database 111 can store any other data that can be useful for advertisers, for example, general advertising statistics, particular advertising statistics based on users' segmentation, and the like.

According to an embodiment of the present invention, Copy/Print Management Server 120 receives advertisements to be embedded into documents to be copied and/or printed by means of copy machines and printers 125, respectively, from Management Application Server 110, and then processes them. It should be noted that said Copy/Print Management Server 120 can contain database 121, which in turn can be used, for example, for caching advertisements received from said Management Application Server 110. Thus, the next time said advertisements have to be provided to users, they can be taken from database 121, eliminating the need to download them again from Management Application Server 110 (from database 111).

It should be noted that Communication Server 115 operates as a gateway between Management Application Server 110 and Copy/Print Management Server 120, handling data traffic passing over a data network. According to another embodiment of the present invention, it can directly access database 111 for retrieving required information (e.g., advertisements, users' personal information, and the like).

According to an embodiment of the present invention, Copy/Print Management Server 120 (by means of a corresponding software and/or hardware) embeds one or more advertisements into the document to be printed and/or copied (e.g., substantially in real-time, when a user prints or copies said document). It should be noted that said document can be provided to Copy/Print Management Server 120 in the PDF (Portable Document Format) format, for example. Also, it should be noted that before embedding one or more advertisements into the document, Copy/Print Management Server 120 checks whether there is a sufficient blank space within the document, at the location where said one or more advertisements should be embedded. If required, the document can be resized (such as reduced in size, for example, up to 90% of its original size), enabling the one or more advertisements to be embedded in a designated location within said document without interfering with the original content of the document.

According to an embodiment of the present invention, Copy/Print Management Server 120 connects to Communication Server 115 each predefined period of time (e.g., once per ten seconds, per a minute, per an hour, and the like) and determines whether Management Application Server 110 received new ads (from advertisers) to be placed within printed and/or copied documents. Also, it determines according to what rules such new ads have to be embedded into printed and/or copied documents.

According to another embodiment of the present invention, a dedicated (or conventional) software component (e.g., a driver) is installed within each user's terminals, such as terminal 151′, 151″ or 151′″. This software component enables users to print their documents, being provided with corresponding embedded advertisements, by means of system 100. As a result, said users print their documents at a lower cost in exchange for having such advertisements.

In addition, according to another embodiment of the present invention, Copy/Print Management Server 120 and/or Management Application Server 110 comprises corresponding software components for controlling an order and rules of all documents to be printed. Such software components decide which ad will be provided within which document to be printed and/or copied, and when. In addition, Copy/Print Management Server 120 can instruct printing the documents on different printers (such as printers 141, 142, etc.) located in different physical locations.

According to an embodiment of the present invention, Management Application Server 110 gathers (and stores within its database 111) users' debit cards personal information (e.g., each user's ID (identification number), gender, age, occupation, etc.), said information received from copy machines and printers 125. Then, based on this gathered information, Copy/Print Management Server 120 matches the most appropriate ad for said each user. It can be assumed, for example, that advertiser 105′ (e.g., a company representative) wishes to advertise a new product by means of system 100. For this, he creates an account by surfing to a predefined Web site over a data network (such as the Internet, cellular network, etc.), and then performs a login into his account. Then, advertiser 105′ defines one or more profiles of users, to which he wishes that his advertisement will be provided; he can define, for example, a main (best match) users' profile and secondary users' profile, as presented in the table below.

TABLE 1
Sample user's profiles.

| Main (Best Match) Users' Profile | Secondary User's Profile |
|---|---|
| Gender: Male | Gender: Male |
| Age: 18-24 | Age: 18-30 |
| Hobby/Fun: video games, sports, | Hobby/Fun: ALL |
| skateboarding. | |
| Occupation: ALL | Occupation: ALL |
| Car owner: ALL | Car owner: ALL |

According to an embodiment of the present invention, when an advertisement is provided to a user, whose personal details match the above main profile, then advertiser 105′ pays a larger sum of money to provider of system 100, than when said advertisement is provided to a user, whose personal details match the above secondary profile. According to another embodiment of the present invention, if a predefined number of successive users (e.g., five users), whose personal details match the secondary profile, print or copy their documents by using system 100, then the advertisement of advertiser 105′ will be provided within the document of the sixth user, even if his personal details also match said secondary profile and not the main profile. According to still another embodiment of the present invention, if for a predefined period of time (e.g., for five minutes) or after a predefined number of document pages (e.g., after fifty pages), no user whose personal details match the main profile, printed or copied documents by using system 100, then during an additional predefined period of time (e.g., ten minutes), the above advertisement of advertiser 105′ will be provided to each user, whose personal details match the secondary profile and not the main profile.

According to an embodiment of the present invention, each user's terminal (such as PC 152′, PDA 152″, cellular phone 152′″) can comprise an application (software component) that gathers various information related to documents that were sent to printing from said terminal (e.g., statistics of printed documents), and presents a survey form on the screen of said each user's terminal to gather user's personal information that may be helpful for designating the most appropriate advertisements to the user. As a reward for completing such a survey form, the user can receive, for example, an additional discount when printing/copying his document(s), or the user can be granted with “points” to be converted to cash or to be used as a discount, when buying one or more predefined products or using one or more predefined services.

According to an embodiment of the present invention, advertisers can select designated users, to which their advertisements will be presented, according to users' geographic location. For example, the advertiser (e.g., a reseller) may login into his account (managed by Management Application Server 110) and specify that he wishes to provide his advertisements for students of the Tel-Aviv University in Israel, or for residents of the zip code “11111” area in United States, and the like. In addition, the advertiser can schedule a time range, within which his advertisement will be presented, such as every three days, every Sunday, every Monday between 4 pm and 6 pm, and the like. Further, the advertiser can setup his advertising budget (e.g., maximum of $100 per a day), limiting the number of advertisements to be provided within users' printed or copied documents.

According to another embodiment of the present invention, the advertiser can specify on which page of the printed or copied document his advertisement will be placed. For example, he can instruct to place his advertisement on the second page of the document that contains five pages. It should be noted that placing the advertisement on the first page of the document may cost more than placing the advertisement on each subsequent page due to a higher exposure of said advertisement, when it is actually located on the first page. In addition, the advertisement may be a “composed advertisement”, i.e., it may contain more than one ad, each to be placed on a separate document page.

According to an embodiment of the present invention, the advertisements are processed, according to an advertisements queue, which can be defined according to a set of user-defined and/or system-defined rules (e.g., priority of each advertisement, users' profile related rules, users' location-based rules, document-based rules (such as a minimal number of pages of the document) and the like). According to another embodiment of the present invention, the advertisements can be processed based on a predefined priority criterion (rule), such as the more an advertiser pays (bids) for placing his advertisement, there is a greater probability that his advertisement will be embedded into the printed and/or copied document according to one or more rules, which were predefined by said advertiser. According to still another embodiment of the present invention, Copy/Print Management Server 120 enables embedding advertisements within a printed or copied document according to a predefined method (algorithm), which in turn enables determining optimal allocations for placing said advertisements within a printed or copied document. It should be noted that the optimal allocations can be determined per each page of said document or per said document as whole. Also, the determining of said optimal allocations can be based on advertisers' settings that are predefined by advertisers, and in turn are stored within database 111 of Management Application Server 110.

According to an embodiment of the present invention, advertisements are processed at least at the following two stages: a) selecting advertisements to be placed within corresponding printed and/or copied documents (i.e., ads selection stage); and b) selecting ads combinations to be printed and/or copied (i.e., ads combination stage). The above ad selection stage involves processing ads rules, which can be either defined by advertisers (advertiser-defined) and/or by a provider of system 100 (system-defined), such as users' profile related rules, location-based rules, document-based rules—e.g., a minimal number of pages of the document, priority of each ad, weight (“importance”) of each advertiser, etc. to get a list of ads that can be embedded within said document). It should be noted that an advertisement may be located on more than one page of the document to be printed and/or copied (e.g., on two or more successive pages). Further, according to still another embodiment of the present invention, at the above ads combination stage, the advertisements within said list of ads (which answer said ads rules) can be randomly selected to be embedded within the document, or selected according to the current queue of advertisements. In addition, it should be noted that a predefined “ads balance” can be maintained: i.e., for example, if an ad is not selected to be embedded within a current document to be printed and/or copied, it can get a preference to be embedded within a successive document. Further, according to still another embodiment of the present invention, the same ads can be embedded within two or more documents of the same user, but in a different order.

It is supposed, for example, that there are three advertising campaigns: Campaign A, Campaign B and Campaign C. Campaign A is predefined to run in the Tel Aviv University only, at any time of the day, and the advertiser of said Campaign A wishes that his advertisements will be placed on the first page of the document to be printed or copied, which in turn has to be at least three pages long. On the other hand, Campaign B is predefined to run in all possible locations (in which system 100 is installed) from 16:00-20:00 every day, and for any document size (e.g., a document that is one, five or a hundred pages long). Further, Campaign C is also predefined to run in all possible locations, at any time of the day, and optimally, for males 26-32 years old; in addition, the ad for this campaign is a multi-banner, which has to be embedded in two or more document pages. In addition, it is supposed, that at 15:30, a document that is three pages long is going to be printed or copied from the Tel-Aviv University by a 24-year old male. Thus, for this particular example, the advertisement of Campaign A is embedded into the first page of the document, and the advertisement of Campaign C (two pages long multi-banner) is embedded into the second and third pages, accordingly. It should be noted that though the advertisement of Campaign C is not an optimal match (since the male is 24-years old and not in the range of 26-32 years, as predefined at Campaign C), it is still the best case scenario according to the above campaign settings.

According to an embodiment of the present invention, a software component that is provided, for example, within Copy/Print Management Server 120 processes and analyzes various possible combinations of advertisements to be embedded by using, for example, a predefined heuristic function (such as a conventional A-star (A*) heuristic function, and the like) in order to determine an optimal combination of advertisements. For this, various factors are considered, which can be generally divided into two main groups: system-defined factors, and user-defined factors. User-defined factors are determined by rules predefined by a user: for example, the user can set a time period rule (every day from 9:00 to 15:00), a location rule (Columbia University, New-York, United States), etc. Further, the user can assign a priority for each rule. On the other hand, system-defined factors are determined by rules predefined by a provider (e.g., a system administrator) of system 100, such as average advertisement spacing, the number of empty slots (to be filled with ads) in each combination of advertisements, and the like.

According to another embodiment of the present invention, each advertiser is assigned with a corresponding weight, which in turn can be determined, for example, by the price said each advertiser pays for placing his advertisement within printed and/or copied documents. It should be noted that said corresponding weight can be predefined by a provider (e.g., a system administrator) of system 100 according to any factor, such as a size of the advertising campaign (a number of advertisements within the campaign), statistical (history) data of each advertiser, advertiser's profile, and the like.

According to an embodiment of the present invention, the priority of each advertising campaign (that can include one or more ads), is determined according to an “Ads Combination Grade”, which can be calculated, for example, by the following expressions:

$$Ads Combination Grade = System Grade + \frac{{\sum }_{i = 1}^{n} ( {U}_{i} ( {ad}_{i} ) \cdot {Weight}_{i} )}{n} , \\ and$$

$$U ( ad ) = \frac{{\sum }_{j = 1}^{m} ( {Rule}_{j} ( ad ) \cdot Rule {Priority}_{j} )}{m} ,$$

wherein “System Grade” parameter is determined by a provider of system 100, according to a number of factors, such as: the number of empty slots in the ads combination; an average ad spacing (size); whether one or more ads within the above ads combination were still not provided to users (were still not embedded within a printed and/or copied document for a predefined period of time, e.g., during the last hour, due to the random selection of ads). The parameter U(ad) represents an advertiser (“U”) that provides a given advertisement (“ad”); Rule(ad) represents a function that determines whether said given ad matches a given rule (it should be noted that, for example, this function can return a value in a range between zero and one); RulePriority parameter assigns a priority (importance) of the rule for the given ad (it should be noted that said RulePriority parameter can be predefined by the advertiser, and it can also, for example, be in a range between zero and one); Weight parameter defines an “importance” of the advertiser, as generally defined above; n is a number of ads in a given ads combination to be embedded within a printed or copied document; m is a number of rules (e.g., predefined by the advertiser) applied to a specific ad within the ads combination; and i and j are indexes.

In addition, according to an embodiment of the present invention, the above “System Grade” parameter can be calculated as follows:

$$System Grade ( combination ) = \frac{\begin{matrix}( 1 - \frac{Empty Slots ( combination )}{NumAds ( combination )} ) + \\ Ad Spacing ( combination )\end{matrix}}{2}$$

$$wherein$$

$$Ad Spacing ( combination ) = \frac{( {{\sum }_{i = 1}}^{n} Spacing ( {ad}_{i} ) )}{n}$$

$$and$$

$$Spacing ( {ad}_{i} ) = ( min Distance ( ad ) ) / n .$$

It should be noted that Empty Slots (combination) parameter is the number of empty slots in the combination of ads to be printed or copied; NumAds (combination) parameter is the number of ads in the combination; minDistance(ad) parameter is the closest spacing (distance) between the same ad in the combination (e.g., if the ad is presented in the combination of ads only once, then the closest distance can be calculated in a closed loop, i.e., starting from this ad and finishing at this ad; thus, as a result, the minDistance parameter for this ad is the number of all ads in the above combination); n is the number of ads in the combination to be printed or copied; and i is an index.

According to an embodiment of the present invention, advertisers can place bids for their advertisements: the higher the bid, the greater the chances are that the corresponding advertisement will be embedded within a better advertising space, allocated within a document to be printed and/or copied (e.g., on the top of the document) or there are greater chances that the corresponding advertisement will be embedded within the next document to be printed or copied.

According to another embodiment of the present invention, a software component that is installed within Copy/Print Management server 120 and/or Management server 110, can calculate and provide a prediction how effective each advertising campaign is going to be by simulating said each advertising campaign, and being based, for example, on performance of previous advertising campaigns within the same advertising field (having the same advertising criteria). In addition, the above software component can determine a probability that a specific advertising campaign will be executed according to one or more rules, which were preset by an advertiser that created said advertising campaign. Thus, the above predictions and probabilities of advertising campaigns can be displayed to advertisers of said campaigns, enabling said advertisers to optimize the performance of their advertising campaigns.

According to an embodiment of the present invention, system 100 uses a predefined threshold (either calculated by said system 100 or provided to said system 100 from an external source) to determine whether the resulting “Ads Combination Grade” is satisfactory, i.e., whether a given ads combination will lead to a desired result. It should be noted that this predefined threshold can be calculated, for example, based on performance of previous ads combinations (already provided to users within copied/printed documents).

It should be noted that according to an embodiment of the present invention, the data network can be any network or any combination of two or more networks, such as the Internet, WWW (World Wide Web), wireless network, satellite network, cable network, cellular network, Ethernet, Intranet, LAN (Local Area Network), WAN (Wide Area Network), or any other network.

Also, it should be noted that advertisements are embedded into the document to be printed or copied substantially in real-time, when a user prints or copies said document by means of a printer or copy machine 125, respectively; i.e., the process (method) of embedding said advertisements is transparent to the user of system 100.

In addition, it should be noted that according to an embodiment of the present invention, the advertiser can pay for his ads also according to the number of a page of the document, within which it is embedded: for example, placing an ad on the first page of the document may cost more than placing said ad on the second page of said document. In turn, placing the ad on the second page may cost more than placing the ad on the third page, or placing the ad on the second page may cost the same as placing the ad on the tenth page, and the like.

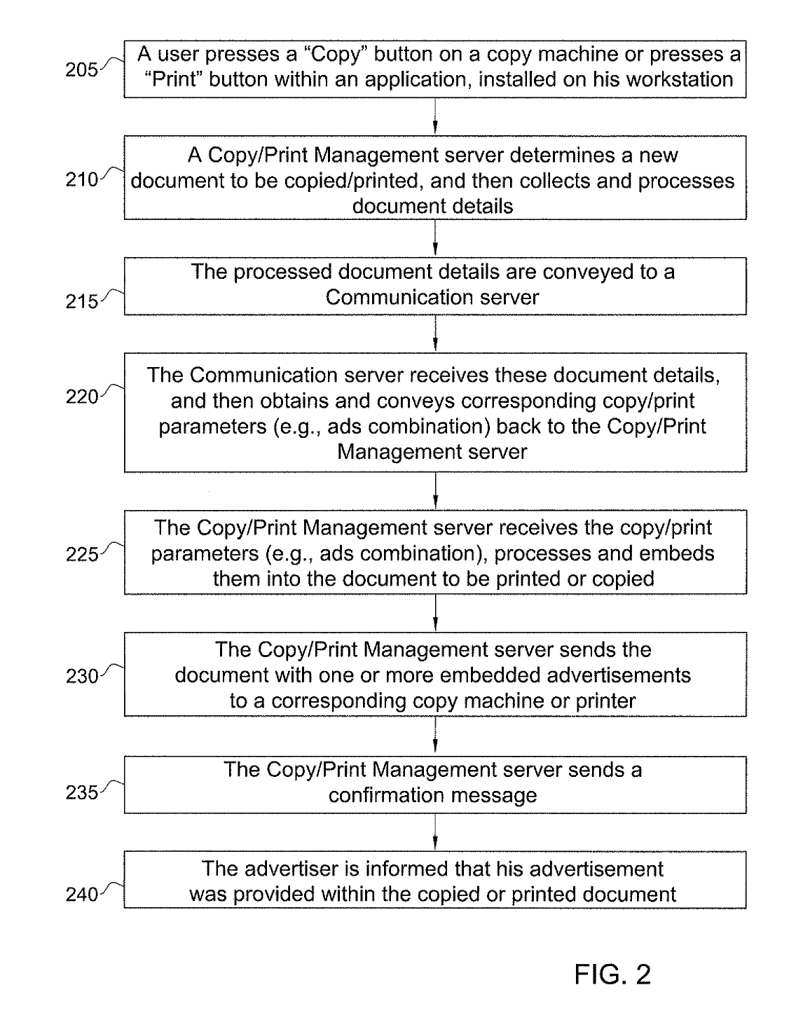

FIG. 2 is a sample flow chart for providing advertisements within a printed and/or copied document, according to an embodiment of the present invention. At step 205, the user presses a “Copy” button on a copy machine (e.g., copy machine 131, 132, etc. (FIG. 1)), or presses a “Print” button within an application, from which he wishes to print his document by means of a printer (e.g., printer 141, 142, etc. (FIG. 1)). Then, at step 210, Copy/Print Management Server 120 (FIG. 1) determines a new document to be processed, collects document details (such as a number of document pages, personal details of a user (user's profile) that prints/copies the document, etc.), and then processes the collected documents details. After this, said document details are sent to Communication Server 115 (FIG. 1), at step 215, which in turn, at step 220, receives them and obtains corresponding print/copy parameters (such as corresponding ads combination to be printed/copied) from Management Application server 110 (FIG. 1). Then, said corresponding ads combination is conveyed back to Copy/Print Management Server 120. In turn, at step 225, Copy/Print Management Server 120 receives said corresponding ads combination and embeds it into a document to be printed or copied. At step 230, Copy/Print Management Server 120 sends the document with the embedded advertising data to a corresponding copy machine or printer (e.g., copy machine 131, printer 141, etc.). Further, at step 235, Copy/Print Management Server 120 sends a confirmation message to Communication Server 115, acknowledging that the document with the corresponding one or more advertisements was printed. Then, at step 240, Communication Server 115 conveys the confirmation message to Management Application server 110 for informing the advertiser that his advertisement was finally provided within a printed or copied document, and was thereby finally presented to a designated user(s).

According to an embodiment of the present invention, a program storage device readable by machine is provided, said program storage device tangibly embodying a program of instructions (e.g., software code) executable by the machine to perform a method of providing a plurality of advertisements over a data network and enabling embedding them into documents to be printed or copied by means of a plurality of users, said method comprising, for example: (a) enabling an advertiser to set up an advertising campaign by enabling him to define one or more advertisements along with defining at least one advertising criterion, giving rise to one or more predefined rules; and (b) enabling embedding at least one of said one or more advertisements into a document to be printed or copied, according to said one or more predefined rules.

While some embodiments of the invention have been described by way of illustration, it will be apparent that the invention can be put into practice with many modifications, variations and adaptations, and with the use of numerous equivalents or alternative solutions that are within the scope of persons skilled in the art, without departing from the spirit of the invention or exceeding the scope of the claims.

1. An advertising management system configured to provide a plurality of advertisements over a data network and embed said plurality of advertisements into documents to be printed or copied by means of a plurality of users, said system comprising:
a) an application management server configured to enable an advertiser to set up an advertising campaign by enabling said advertiser to define one or more advertisements along with defining at least one advertising criterion, giving rise to one or more predefined rules; and
b) an advertisement management server configured to enable embedding at least one of said one or more advertisements into a document to be printed or copied, according to said one or more predefined rules.

2. The advertising management system according to claim 1, wherein the advertisement management server further embeds the at least one of the one or more advertisements, according to one or more rules predefined by a provider of said advertising management system.

3. The advertising management system according to claim 1, wherein the advertising management system determines a combination of advertisements to be embedded within the document to be printed or copied.

4. The advertising management system according to claim 3, wherein the combination of advertisements to be embedded is determined according to one or more rules predefined by a provider of said advertising management system and/or the advertiser.

5. The advertising management system according to claim 1, further comprising a communication server configured to provide a gateway between the application management server and advertisement management server.

6. The advertising management system according to claim 1, wherein the application management server and advertisement management server are unified and physically located on the same server.

7. The advertising management system according to claim 1, wherein the at least one of the one or more advertisements is embedded into the document to be printed or copied substantially in real-time.

8. The advertising management system according to claim 1, wherein the application management server further comprises a database.

9. The advertising management system according to claim 8, wherein the database is used for one or more of the following: a) storing the advertisements to be embedded into the documents to be printed or copied; b) storing personal details of the users who print or copy said documents; and c) storing data being related to said users.

10. The advertising management system according to claim 1, wherein the advertisement management server further comprises a database.

11. The advertising management system according to claim 10, wherein the database is used for one or more of the following: a) enabling caching of advertisements provided from the application management server; b) storing personal details of the users who print or copy said documents; and c) storing data being related to said users.

12. A method of providing a plurality of advertisements over a data network and enabling embedding them into documents to be printed or copied by means of a plurality of users, said method comprising:
a) enabling an advertiser to set up an advertising campaign by enabling him to define one or more advertisements along with defining at least one advertising criterion, giving rise to one or more predefined rules; and
b) enabling embedding at least one of said one or more advertisements into a document to be printed or copied, according to said one or more predefined rules.

13. The method according to claim 12, further comprising embedding the one or more advertisements into the document to be printed or copied substantially in real-time.

14. The method according to claim 12, further comprising embedding the one or more advertisements into the document to be printed or copied according to at least one rule, which is not predefined by the advertiser.

15. The method according to claim 12, further comprising determining a combination of advertisements to be embedded within the document to be printed or copied.

16. A program storage device readable by machine, tangibly embodying a program of instructions executable by the machine to perform a method of providing a plurality of advertisements over a data network and enabling embedding them into documents to be printed or copied by means of a plurality of users, said method comprising:
a) enabling an advertiser to set up an advertising campaign by enabling him to define one or more advertisements along with defining at least one advertising criterion, giving rise to one or more predefined rules; and
b) enabling embedding at least one of said one or more advertisements into a document to be printed or copied, according to said one or more predefined rules.

17. The program storage device according to claim 16, wherein the method further comprises embedding the one or more advertisements into the document to be printed or copied substantially in real-time.

18. The program storage device according to claim 16, wherein the method further comprises embedding the one or more advertisements into the document to be printed or copied according to at least one rule, which is not predefined by the advertiser.

19. The program storage device according to claim 16, wherein the method further comprises determining a combination of advertisements to be embedded within the document to be printed or copied.
